(19) United States
(12) Patent Application Publication
(10) Pub. No.: US 2025/0355967 A1
(43) Pub. Date: Nov. 20, 2025

(54) DATA PROCESSING DEVICE AND DATA PROCESSING METHOD

(71) Applicant: Mitsubishi Electric Corporation, Tokyo (JP)

(72) Inventors: Akira Minezawa, Tokyo (JP); Teng-Yok LEE, Tokyo (JP); Yusuke NAGAI, Tokyo (JP)

(73) Assignee: Mitsubishi Electric Corporation, Tokyo (JP)

(21) Appl. No.: 19/282,694

(22) Filed: Jul. 28, 2025

Related U.S. Application Data
(63) Continuation of application No. PCT/JP2023/004481, filed on Feb. 10, 2023.

(51) Int. Cl. G06F 17/16

(52) U.S. Cl. CPC G06F 17/16

(57) ABSTRACT

A data processing device according to the present disclosed technology includes a processing circuit, in which the processing circuit sequentially updates a gram matrix in a form of SVD in a learning phase, and the processing circuit calculates a variance-covariance matrix in the form of SVD on the basis of SVD related to the gram matrix in Finalization of the learning phase.

### CROSS REFERENCE TO RELATED APPLICATION

This application is a Continuation of PCT International Application No. PCT/JP2023/004481, filed on Feb. 10, 2023, which is hereby expressly incorporated by reference into the present application.

### TECHNICAL FIELD

The present disclosed technology relates to a data processing device and a data processing method.

### BACKGROUND ART

Data processing devices are utilized in the field of machine learning, for example. Problems handled by machine learning roughly include supervised learning and unsupervised learning. As one of the supervised learning, there is a problem of predicting a category, that is, “classification”. In addition, the unsupervised learning also includes a problem of finding a group, that is, “clustering”. The data processing device is used as an artificial intelligence device that performs “classification” or an artificial intelligence device that performs “clustering”.

As artificial intelligence that performs “classification” or “clustering” for images, for example, an artificial neural network such as a convolution neural network (CNN) has achieved a great result. The artificial neural network generates an image feature amount from image data. The image feature amount is a vector amount that can be expressed as a vector in the feature space. The data processing device determines the degree of similarity or the degree of deviation on the basis of a distance that can be defined in the feature space, for example, the Mahalanobis distance. The degree of similarity and the degree of deviation are both important quantities required in “classification” or “clustering”.

A classification and clustering technique in machine learning is applied to abnormality detection for detecting an abnormality from an image. More specifically, it is assumed that the occurrence probability of a sample belonging to a certain class in the feature space can be expressed by a normal distribution, and the abnormality detection is performed on the basis of the “Mahalanobis distance” taking the estimation result of the normal distribution into consideration. For example, Non-Patent Literature 1 discloses a technique in which a trained general-purpose CNN is applied to abnormality detection using a technique called patch distribution modeling (sometimes simply referred to as “PaDiM”).

### CITATION LIST

### Non-Patent Literature

Non-Patent Literature 1: by Thomas Defard et al. “PaDiM: a Patch Distribution Modeling Framework for Anomaly Detection and Localization” (https://arxiv.org/abs/2011.08785)

### SUMMARY OF INVENTION

### Technical Problem

The Mahalanobis distance is a distance defined by a variance-covariance matrix (Σ). When the dimension of the feature space is N_{f}, the variance-covariance matrix (Σ) is a matrix whose size is N_{f}×N_{f}. The variance-covariance matrix (Σ) is updated on the basis of the training data in the learning phase. In the inference phase, the calculation of the Mahalanobis distance usually requires an inverse matrix of a variance-covariance matrix (Σ), which is a matrix whose size is N_{f}×N_{f}.

As an algorithm for updating the variance-covariance matrix (Σ) in the learning phase, an algorithm having affinity with singular value decomposition, more specifically, an algorithm having affinity with low ranking approximation based on singular value decomposition is required.

### Solution to Problem

A data processing device according to the present disclosed technology includes a processing circuit, in which the processing circuit sequentially updates a gram matrix in a form of SVD in a learning phase, and the processing circuit calculates a variance-covariance matrix in the form of SVD on the basis of SVD related to a gram matrix to be described later in Finalization of the learning phase.

### Advantageous Effects of Invention

A data processing device according to the present disclosed technology includes the above configuration, and an algorithm for updating a variance-covariance matrix (Σ) in a learning phase has affinity with singular value decomposition and also has affinity with low ranking approximation based on singular value decomposition.

As a result, the data processing device and the data processing method according to the present disclosed technology can benefit from the singular value decomposition and the low ranking approximation based on the singular value decomposition in the learning phase.

### BRIEF DESCRIPTION OF DRAWINGS

FIG. 1A and FIG. 1B are hardware configuration diagrams illustrating a hardware configuration of a data processing device according to a first embodiment.

FIG. 2 is a block diagram schematically illustrating a function used by the data processing device according to the present disclosed technology.

FIG. 3 is a block diagram schematically illustrating a parameter update technique used by the data processing device according to the first embodiment.

FIG. 4 is a first flowchart illustrating processing steps in parameter update of the data processing device according to the first embodiment.

FIG. 5 is a second flowchart illustrating processing steps in parameter update of the data processing device according to the first embodiment.

FIG. 6 is a flowchart illustrating processing steps in distance calculation of the data processing device according to the first embodiment.

FIG. 7 is an explanatory diagram illustrating a data processing method according to a second embodiment.

FIG. 8 is an explanatory diagram illustrating a data processing method according to a third embodiment.

### DESCRIPTION OF EMBODIMENTS

### <<Introduction 1>>

It is assumed that an image feature amount (x) handled by the present disclosed technology is given by a vertical vector (column vector) as follows.

$$for c = 1 to {N}_{d} \\ {x}_{c} ∈ {ℝ}^{{N}_{f} \times 1} \qquad ( 1 )$$

Here, N_{f} represents a length of the feature amount. The lower right subscript “f” in N_{f} is derived from the initial letter of feature. N_{d} represents the number of pieces of training data. Note that, in the present specification, the training data is hereinafter simply referred to as “data”. The lower right subscript “d” in N_{d} is derived from the initial letter of data. In addition, c of the variable is derived from the initial letter of column which means a column (see the following Mathematical Formula (2)).

A data matrix (X) formed by arranging image feature amounts of a plurality of images belonging to a certain class is given by the following mathematical formula.

$$X {\vert}_{{N}_{d}} = ⌊ {x}_{1} , … {x}_{c} , … {x}_{{N}_{d}} ⌋ \\ therefore \\ X {\vert}_{{N}_{d}} ∈ {ℝ}^{{N}_{f} \times {N}_{d}} \qquad ( 2 )$$

In the present specification, unless otherwise specified, it is assumed that the number of pieces of data is sufficient and N_{d}>N_{f}.

An expected value (μ) of the image feature amount belonging to the class is expressed by the following mathematical formula.

$$\begin{matrix}μ {\vert}_{{N}_{d}} = E ( X {\vert}_{{N}_{d}} ) \\ = \frac{1}{{N}_{d}} {\sum }_{c = 1}^{{N}_{d}} {x}_{c}\end{matrix} \\ therefore \\ μ {\vert}_{{N}_{d}} ∈ {ℝ}^{{N}_{f} \times 1} \qquad ( 3 )$$

Here, E( ) of the function represents an expected value. In general, the expected value and an average value have different concepts, but in this case, the expected value (μ) of the image feature amount is equal to the average (hereinafter, referred to as “average feature amount”) of the N_{d} image feature amounts belonging to the class.

The variance-covariance matrix (Σ) for the data matrix (X) is given by the following mathematical formula using μ.

$${\overbrace{\sum {\vert}_{{N}_{d}}}}^{{variance ‐ convariance}_{matrix}} = {\overbrace{E ( {\overbrace{X {\vert}_{{N}_{d}} {X}^{T} {\vert}_{{N}_{d}}}}^{gram matrix} )}}^{correlation matrix} - μ {\vert}_{{N}_{d}} {μ}^{T} {\vert}_{{N}_{d}} \\ therefore \\ \sum {\vert}_{{N}_{d}} ∈ {ℝ}^{{N}_{f} \times {N}_{f}} \qquad ( 4 )$$

Here, the upper right subscript “T” appearing in Mathematical Formula (4) represents transposition. Note that the variance-covariance matrix may be simply referred to as a “covariance matrix”. In addition, XX^{T} appearing in the first term on the right side of Mathematical Formula (4) is referred to as a gram matrix. Furthermore, the expected value of the gram matrix, that is, E (XX^{T}) of the first term on the right side of Mathematical Formula (4) is referred to as a correlation matrix.

The variance-covariance matrix (Σ) can be derived by modifying Mathematical Formula (4), but can also be expressed by using a deviation vector (x_{c}−μ) from the average.

$$\begin{matrix}\sum {\vert}_{{N}_{d}} = E ( [ {x}_{1} - μ {\vert}_{{N}_{d}} , … {x}_{{N}_{d}} - μ {\vert}_{{N}_{d}} ] [ \begin{matrix}{( {x}_{1} - μ {\vert}_{{N}_{d}} )}^{T} \\ ⋮ \\ {( {x}_{{N}_{d}} - μ {\vert}_{{N}_{d}} )}^{T}\end{matrix} ] ) \\ \frac{1}{{N}_{d}} [ {x}_{1} - μ {\vert}_{{N}_{d}} , … {x}_{{N}_{d}} - μ {\vert}_{{N}_{d}} ] [ \begin{matrix}{( {x}_{1} - μ {\vert}_{{N}_{d}} )}^{T} \\ ⋮ \\ {( {x}_{{N}_{d}} - μ {\vert}_{{N}_{d}} )}^{T}\end{matrix} ]\end{matrix} \qquad ( 5 )$$

Here, if the deviation vector (x_{c}−μ) of the c-th column is y_{c} again, Mathematical Formula (5) can be modified as follows.

$${y}_{c} := {x}_{c} - μ {\vert}_{{N}_{d}} \\ then \\ \begin{matrix}\sum {\vert}_{{N}_{d}} = {\overbrace{\frac{1}{\sqrt{{N}_{d}}} [ {y}_{1} , … {y}_{{N}_{d}} ]}}^{= : Q} {\overbrace{\frac{1}{\sqrt{{N}_{d}}} [ \begin{matrix}{y}_{1}^{T} \\ ⋮ \\ {y}_{{N}_{d}}^{T}\end{matrix} ]}}^{= : {Q}^{T}} \\ ≽ 0\end{matrix} \qquad ( 6 )$$

The second row of Mathematical Formula (6) indicates that the variance-covariance matrix (Σ) can be expressed as QQ^{T}, that is, the variance-covariance matrix (Σ) is a positive-semidefinite matrix.

The Mahalanobis distance (d_{M}) is often used to measure the degree of similarity or the degree of deviation of the target sample (x_{target}) using the measurement result of the normal distribution. The Mahalanobis distance (d_{M}) is given by the following mathematical formula using a variance-covariance matrix (Σ).

$${\overbrace{{d}_{M}}}^{∈ ℝ} = \sqrt{{( {x}_{target} - μ {\vert}_{{N}_{d}} )}^{T} {\sum }^{- 1} {\vert}_{{N}_{d}} ( {x}_{target} - μ {\vert}_{{N}_{d}} )} \\ when \\ \sum {\vert}_{{N}_{d}} ≻ 0 \qquad ( 7 )$$

As shown in Mathematical Formula (7), the Mahalanobis distance (d_{M}) is a distance that can be defined when an inverse matrix (Σ-1) of the variance-covariance matrix (Σ) exists, that is, when the variance-covariance matrix (Σ) is a positive definite value. The Mahalanobis distance (d_{M}) represented by Mathematical Formula (1) to Mathematical Formula (7) is a distance defined in a feature space having a dimension of N_{f}.

The present disclosed technology is interested in and demonstrates how a variance-covariance matrix (Σ) is updated when data belonging to a certain class increases from N_{d} to N_{d}+1. If the variance-covariance matrix (Σ) when the number of pieces of data is increased to N_{d}+1 is given in the singular value decomposition form, the inverse matrix (Σ⁻¹) of the variance-covariance matrix (Σ) for calculating the Mahalanobis distance (d_{M}) can be easily obtained.

### <<Introduction 2>>

It is known that any matrix can be represented by a singular value and a singular vector thereof. A form in which a matrix is decomposed into a singular value and a singular vector is referred to as singular value decomposition. A singular value decomposition of a certain p×q matrix (Z≠0) is expressed as follows.

$${\overbrace{Z}}^{∈ {ℝ}^{p \times q}} = {\overbrace{[ {u}_{1} , … {u}_{r} ]}}^{U ∈ {ℝ}^{p \times r}} {\overbrace{[ \begin{matrix}{σ}_{1} & & \\ & ⋱ & \\ & & {σ}_{r}\end{matrix} ]}}^{S ∈ {ℝ}^{r \times r}} {\overbrace{[ \begin{matrix}{v}_{1}^{T} \\ ⋮ \\ {v}_{r}^{T}\end{matrix} ]}}^{{V}^{T} ∈ {ℝ}^{r \times q}} \qquad ( 8 )$$

Here, r represents a rank of Z. {σ₁, . . . , σᵣ} appearing in Mathematical Formula (8) are singular values of Z. S is a diagonal matrix having a singular value {σ₁, . . . , σᵣ} as a component. The {u₁, . . . , uᵣ} appearing in Mathematical Formula (8) is referred to as a left singular vector with respect to the singular value {σ₁, . . . , σᵣ}. {v₁, . . . , vᵣ} appearing in Mathematical Formula (8) is referred to as a right singular vector with respect to the singular value {σ₁, . . . , σᵣ}. The left singular vector and the right singular vector are collectively referred to as a singular vector.

Studies have been conducted to determine singular value decomposition of Z+AB^{T} when singular value decomposition of a certain p×q matrix (Z≠0) is given. For example, the following Non-Patent Literature discloses the algorithm.

Matthew Brand, “Fast Low-Rank Modifications of the Thin Singular Value Decomposition”, MERL Technical Report, TR2006-059, May 2006.

An algorithm to determine singular value decomposition of Z+AB^{T} is described as a program and can be a function of a function library. In the present specification, the function to determine the singular value decomposition of Z+AB^{T} is expressed as “IncrSVD” as follows.

$$\{ {U}_{out} , {S}_{out} , {V}_{out} \} = {\overbrace{IncrSVD}}^{function} \{ {U}_{in} , {S}_{in} , {V}_{in} , {A}_{in} , {B}_{in} \} \\ wherein \\ {U}_{out} {S}_{out} {V}_{out}^{T} = {\overbrace{{U}_{in} {S}_{in} {V}_{in}^{T}}}^{z} + {A}_{in} {B}_{in}^{T} \qquad ( 9 )$$

Here, Incr is derived from the first four characters of Incremental meaning sequential, and SVD is derived from the initial letters of Singular Value Decomposition meaning singular value decomposition.

### <<Introduction 3>>

When a certain matrix (Z, Z≠0) can be expressed by singular value decomposition (see Mathematical Formula (8)), the Moore-Penrose type general inverse matrix (hereinafter, simply referred to as a “general inverse matrix”, which is also referred to as a pseudo inverse matrix) is given by the following mathematical formula.

$$\begin{matrix}{\overbrace{{Z}^{-}}}^{∈ {ℝ}^{q \times p}} = {\overbrace{V}}^{∈ {ℝ}^{q \times r}} {\overbrace{[ \begin{matrix}\frac{1}{{σ}_{1}} & & \\ & ⋱ & \\ & & \frac{1}{{σ}_{r}}\end{matrix} ]}}^{{S}^{- 1} ∈ {ℝ}^{r \times r}} {\overbrace{{U}^{T}}}^{∈ {ℝ}^{r \times p}} \\ = \frac{1}{{σ}_{1}} {\overbrace{{v}_{1} {u}_{1}^{T}}}^{∈ {ℝ}^{q \times p}} + … + \frac{1}{{σ}_{r}} {\overbrace{{v}_{r} {u}_{r}^{T}}}^{∈ {ℝ}^{q \times p}}\end{matrix} \qquad ( 10 )$$

When Z is a regular matrix (p=q), the general inverse matrix (Z⁻) of Z is matched with the inverse matrix (Z⁻¹) of Z. Inverse matrices are only defined for regular matrices, whereas general inverse matrices are defined for non-zero matrices. However, to calculate the general inverse matrix, the rank must be known.

Since the vector is also a kind of matrix, the general inverse matrix is also defined for the vector.

In general, calculations handled in physics and engineering always include calculation errors because they use observation data obtained from measurement devices and sensors. This is not an exception also in the technical field to which the data processing device 100 according to the present disclosed technology belongs. Therefore, when singular value decomposition is calculated for a matrix calculated on the basis of observation data, all singular values (σᵢ, i is a natural number from 1 to N_{f}) in numerical calculation are positive. In a case where a singular value that is originally zero becomes non-zero due to an error in numerical calculation, if an inverse matrix (including a general inverse matrix) of the matrix is calculated as it is, the singular value becomes an unrealistic value due to 1/σᵢ.

In order to determine the rank of Z in the p×q matrix obtained from the measurement data, a method of first setting a tentative rank (l=min(p, q)) and calculating the following singular value decomposition is adopted.

$$Z = {σ}_{1} {u}_{1} {v}_{1}^{T} + … + {σ}_{l} {u}_{l} {v}_{l}^{T} \\ wherein \\ l = min ( p , q ) \\ {σ}_{1} \geq … \geq {σ}_{l} \qquad ( 11 )$$

In the method for determining the rank, it is then examined from which singular value the value of the singular value at the end can be approximated to zero. As the specification of a tolerance of the rank of the matrix, for example, a minimum limit value that can be handled by a computer (referred to as a “machine epsilon”) is used.

$${σ}_{r + 1} \approx 0 , … {σ}_{l} \approx 0 \qquad ( 12 )$$

(Z)ᵣ in a case where the rank of Z is r is given by the following mathematical formula.

$${( Z )}_{r} := {σ}_{1} {u}_{1} {v}_{1}^{T} + … + {σ}_{r} {u}_{r} {v}_{r}^{T} \qquad ( 13 )$$

A technique similar to the creation of (Z)ᵣ defined by Mathematical Formula (13) includes “low ranking approximation based on singular value decomposition”. The general inverse matrix for the low ranking approximated matrix is referred to as a “rank-constrained general inverse matrix”. The rank-constrained general inverse matrix is also referred to as a rank-constrained pseudo inverse matrix.

The following relational expression is established between Z and (Z)ᵣ.

$$Z - {( Z )}_{r} = U [ \begin{matrix}0 & & & & & \\ & ⋱ & & & & \\ & & 0 & & & \\ & & & {σ}_{r + 1} & & \\ & & & & ⋱ & \\ & & & & & {σ}_{l}\end{matrix} ] {V}^{T} \qquad ( 14 )$$

The error between Z and (Z)ᵣ is given by the following mathematical formula.

$$\vert \vert {( Z )}_{r} - Z \vert \vert = \sqrt{{σ}_{r + 1}^{2} + … + {σ}_{l}^{2}} \qquad ( 15 )$$

Here, a symbol appearing on the left side of Mathematical Formula (15) is Frobenius norm or Euclidean norm.

The rank-constrained general inverse matrix is a general inverse matrix using low ranking approximation based on singular value decomposition. The low ranking approximation based on singular value decomposition has properties (disadvantages and advantages) similar to general approximation. The disadvantage of approximation is that an error from a true value occurs. The advantage of approximation is that information can be slimmed to a necessary amount. The low ranking approximation based on singular value decomposition also has a disadvantage that an error from a true value occurs and an advantage that information can be slimmed to a necessary amount.

Many of the matters described in Introduction 3 are cited from Cited Document 1 described below. Further, a proof for deriving an error indicated in Mathematical Formula (15) is described in Cited Document 1.

Cited Document 1: Kenichi Kanaya, “linear algebraic seminar, projection, singular value decomposition, general inverse matrix”, Kyoritsu Shuppan, ISBN978-4-320-11340-4.

### First Embodiment

The data processing device 100 according to a first embodiment illustrates a minimum necessary configuration required for the data processing device 100 according to the present disclosed technology.

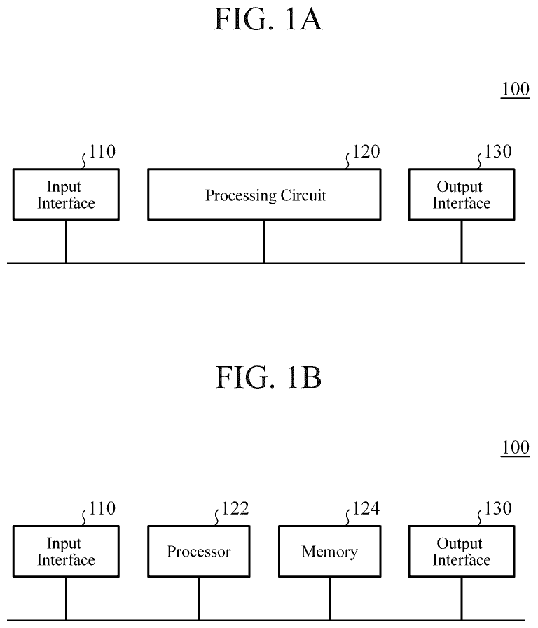

FIG. 1A and FIG. 1B are hardware configuration diagrams illustrating a hardware configuration of the data processing device 100 according to the first embodiment.

FIG. 1A is a hardware configuration diagram illustrating a hardware configuration in a case where functions of the data processing device 100 according to the first embodiment are executed by dedicated hardware. As illustrated in FIG. 1A, the hardware configuration when executed by dedicated hardware includes an input interface 110, a processing circuit 120, and an output interface 130.

The processing circuit 120 corresponds to, for example, a single circuit, a composite circuit, a programmed processor, a parallel programmed processor, ASIC, FPGA, or a combination thereof. The functions of the data processing device 100 may be implemented by separate processing circuits 120, or may be collectively implemented by one processing circuit 120.

FIG. 1B is a hardware configuration diagram illustrating a hardware configuration in a case where the functions of the data processing device 100 according to the first embodiment are executed by software. As illustrated in FIG. 1B, the hardware configuration when executed by software includes the input interface 110, a processor 122, a memory 124, and the output interface 130.

The processor 122 is also generally referred to as a central processing unit (CPU), a central processing unit, a processing unit, an arithmetic unit, a microprocessor, a microcomputer, or a digital signal processor (DSP).

In a case where the hardware configuration of the data processing device 100 is as illustrated in FIG. 1B, each function of the data processing device 100 is implemented by software, firmware, or a combination of software and firmware. The software and the firmware are described as programs and stored in the memory 124. The processor 122 implements each function by reading and executing the program stored in the memory 124. That is, the data processing device 100 includes the memory 124 for storing a program that results in execution of each processing step when executed by the processor 122. In addition, it can also be said that these programs cause the processor 122 to execute the procedure and method of the data processing device 100 (data processing method according to the present disclosed technology). Here, the memory 124 may be, for example, a nonvolatile or volatile semiconductor memory such as RAM, ROM, a flash memory, or EPROM. The memory 124 may include a disk such as a magnetic disk, a flexible disk, an optical disk, a compact disk, a mini disk, or a DVD. Furthermore, the memory 124 may be in the form of a hard disk drive (HDD) or a solid state drive (SSD).

Note that some of the functions of the data processing device 100 according to the first embodiment may be implemented by dedicated hardware, and the others may be implemented by software or firmware.

As described above, in the data processing device 100 according to the first embodiment, the above-described functions are implemented by hardware, software, firmware, or a combination thereof.

A technical feature of the data processing device 100 according to the present disclosed technology is that the variance-covariance matrix (Σ) is neither stored nor used in the form of one matrix having a size of N_{f}×N_{f}.

Since the variance-covariance matrix (Σ) expressed by Mathematical Formula (6) is a positive-semidefinite matrix, the variance-covariance matrix (Σ) can be modified as follows.

$$\sum {\vert}_{{N}_{d}} = Q {\vert}_{{N}_{d}} {Q}^{T} {\vert}_{{N}_{d}} \qquad ( 16 )$$

Next, it is assumed that Q of a matrix appearing in Mathematical Formula (16) is expressed in a singular value decomposition format.

$$Q {\vert}_{{N}_{d}} = U {\vert}_{{N}_{d}} {\overbrace{[ \begin{matrix}{σ}_{1} & & \\ & ⋱ & \\ & & {σ}_{{N}_{f}}\end{matrix} ]}}^{S {\vert}_{{N}_{d}}} {V}^{T} {\vert}_{{N}_{d}} \qquad ( 17 )$$

In the present specification, the singular values are arranged in order of magnitude, and it is assumed that σ₁≥σ₂≥ . . . ≥σ_{NF}. In general, sigma (particularly “σ²”) is often used as a symbol representing a variance, but in the present specification, as described above, sigma represents a singular value.

The following mathematical formulas hold for U and V appearing in Mathematical Formula (17) due to the property of the singular vector.

$$\{ \begin{matrix}{U}^{T} {\vert}_{{N}_{d}} U {\vert}_{{N}_{d}} = {\overbrace{I}}^{∈ {ℝ}^{{N}_{f} \times {N}_{f}}} \\ {V}^{T} {\vert}_{{N}_{d}} V {\vert}_{{N}_{d}} = {\overbrace{I}}^{∈ {ℝ}^{{N}_{f} \times {N}_{f}}}\end{matrix} \qquad ( 18 )$$

Here, I appearing in Mathematical Formula (18) is a unit matrix having a size of N_{f}×N_{f}.

By substituting the singular value decomposition shown in Mathematical Formula (17) into Mathematical Formula (16), the variance-covariance matrix (Σ) can be decomposed as follows.

$$\sum {\vert}_{{N}_{d}} = U {\vert}_{{N}_{d}} {\overbrace{[ \begin{matrix}{( {σ}_{1} )}^{2} & & \\ & ⋱ & \\ & & {( {σ}_{{N}_{f}} )}^{2}\end{matrix} ]}}^{{S}^{2} {\vert}_{{N}_{d}}} {U}^{T} {\vert}_{{N}_{d}} \qquad ( 19 )$$

As shown in Mathematical Formula (19), {σ₁², σ₂², . . . , σ_{Nf}²} are singular values of the variance-covariance matrix (Σ).

The inverse matrix (Σ⁻¹) of the variance-covariance matrix (Σ) is given by the following mathematical formula by the property expressed by Mathematical Formula (18) and Mathematical Formula (19).

$$\begin{matrix}{\sum }^{- 1} {\vert}_{{N}_{d}} = {\sum }^{-} {\vert}_{{N}_{d}} \\ = U {\vert}_{{N}_{d}} {\overbrace{[ \begin{matrix}{( {σ}_{1} )}^{- 2} & & \\ & ⋱ & \\ & & {( {σ}_{{N}_{f}} )}^{- 2}\end{matrix} ]}}^{{S}^{- 2} {\vert}_{{N}_{d}}} {U}^{T} {\vert}_{{N}_{d}}\end{matrix} \qquad ( 20 )$$

As described above, in the case of a regular matrix, the general inverse matrix is matched with the inverse matrix. Note that, in the derivation of Mathematical Formula (20), all the singular values of the variance-covariance matrix (Σ) are assumed to be non-zero. A countermeasure for the case where the variance-covariance matrix (Σ) is not the full rank will be apparent from the following description.

In the present specification, a form in which a matrix is decomposed and expressed by a product of the matrices is referred to as a “decomposition form”. The singular value decomposition is a kind of decomposition form, and is a special form. The singular value decomposition is also given on the right side of Mathematical Formula (20). When the variance-covariance matrix (Σ) is given by singular value decomposition as described above, it is possible to cope with a problem that the matrix apparently becomes full rank due to a numerical error (see Introduction 3). Herein, singular value decomposition may also be referred to as SVD.

The data processing device 100 according to the present disclosed technology calculates the Mahalanobis distance (d_{M}) using the decomposition form given on the right side of Mathematical Formula (20).

$${d}_{M}^{2} = {\overbrace{{( {x}_{target} - μ {\vert}_{{N}_{d}} )}^{T}}}^{{y}_{target}^{T}} {\overbrace{U {\vert}_{{N}_{d}} {S}^{- 2} {\vert}_{{N}_{d}} {U}^{T} {\vert}_{{N}_{d}}}}^{{\sum }^{- 1} {\vert}_{{N}_{d}}} {\overbrace{( {x}_{target} - μ {\vert}_{{N}_{d}} )}}^{{y}_{target}} \qquad ( 21 )$$

As shown in Mathematical Formula (21), there is no problem even if a square (d_{M}²) of the Mahalanobis distance (d_{M}) is used instead of the Mahalanobis distance (d_{M}) in order to measure the degree of similarity or the degree of deviation of a certain sample (x_{target}). Furthermore, as illustrated in Mathematical Formula (21), the feature amount (x_{target}) for the target may also be represented by a deviation vector (y_{target}=x_{target}−μ) defined as a deviation from the average feature amount (μ).

(Update Method when Data Increases)

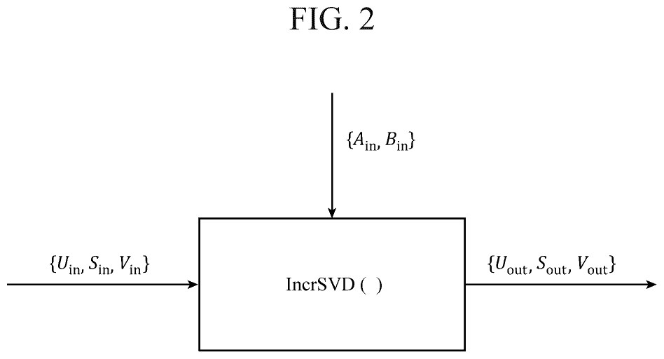

FIG. 2 is a block diagram schematically illustrating a function used by the data processing device 100 according to the present disclosed technology. More specifically, FIG. 2 is a block diagram illustrating IncrSVD( ), which is a function expressed by Mathematical Formula (9).

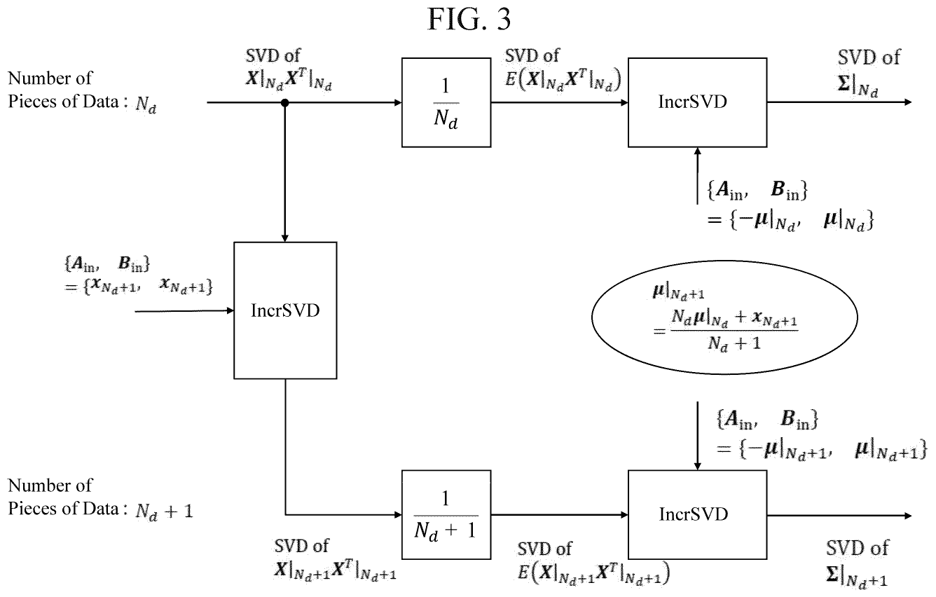

FIG. 3 is a block diagram schematically illustrating a data update technique used by the data processing device 100 according to the first embodiment. More specifically, FIG. 3 is a block diagram schematically illustrating a data update technique performed by the data processing device 100 according to the first embodiment when the number of pieces of data increases from N_{d} to N_{d}+1.

It is ideal if U, S, and V, which are matrices in the singular value decomposition form of the variance-covariance matrix (Σ), can be directly updated when the number of pieces of data increases, but it is not essential. As illustrated in FIG. 3, when the number of pieces of data increases, the data processing device 100 according to the first embodiment updates the SVD of the gram matrix using the first IncrSVD( ), and obtains the SVD of the variance-covariance matrix (Σ) from the SVD of the correlation matrix using the second IncrSVD( ). In FIG. 3, the first IncrSVD( ) is shown as a vertically long block and the second IncrSVD( ) is shown as a horizontally long block.

When the number of pieces of data is N_{d}, the SVD of the gram matrix is given as follows.

$$X {\vert}_{{N}_{d}} {X}^{T} {\vert}_{{N}_{d}} = {U}_{0} {S}_{0} {V}_{0}^{T} \qquad ( 22 )$$

Here, the lower right subscript “0” attached to the matrix appearing on the right side of Mathematical Formula (22) is merely a number for identifying which matrix the SVD is for.

When the number of pieces of data is increased to N_{d}+1, the gram matrix is updated using the first IncrSVD( ).

$$\{ {U}_{1} , {S}_{1} , {V}_{1} \} = IncrSVD \{ {U}_{0} , {S}_{0} , {V}_{0} , {x}_{{N}_{d} + 1} , {x}_{{N}_{d} + 1} \} \\ wherein \\ {U}_{1} {S}_{1} {V}_{1}^{T} = X {\vert}_{{N}_{d} + 1} {X}^{T} {\vert}_{{N}_{d} + 1} \qquad ( 23 )$$

Here, the lower right suffix “1” added to the matrix appearing on the left side of Mathematical Formula (23) is a number for identifying which matrix the SVD is for, similarly to “0” in Mathematical Formula (22).

The relationship between the gram matrix and the correlation matrix is described in Mathematical Formula (4). That is, the expected value of the gram matrix is a correlation matrix. With this relationship, the SVD of the correlation matrix is given as follows.

$$\begin{matrix}E ( X {\vert}_{{N}_{d} + 1} {X}^{T} {\vert}_{{N}_{d} + 1} ) = \frac{1}{{N}_{d} + 1} X {\vert}_{{N}_{d} + 1} {X}^{T} {\vert}_{{N}_{d} + 1} \\ = {U}_{1} ( \frac{1}{{N}_{d} + 1} {S}_{1} ) {V}_{1}^{T}\end{matrix} \qquad ( 24 )$$

When x_{nd+1} is newly added to the data, the average feature amount (μ|N_{d}+1) is updated as follows.

$$μ {\vert}_{{N}_{d} + 1} = \frac{{N}_{d}}{{N}_{d} + 1} μ {\vert}_{{N}_{d}} + \frac{1}{{N}_{d} + 1} {x}_{{N}_{d} + 1} \qquad ( 25 )$$

The process illustrated in Mathematical Formula (25) is referred to as “update of the average feature amount”.

Finally, the SVD of the variance-covariance matrix (Σ) when the number of pieces of data is N_{d}+1 is given as follows using the updated average feature amount (μ|N_{d}+1) and the second IncrSVD ( )

$$\begin{matrix}\{ \begin{matrix}{U}_{2} , & {S}_{2} , & {V}_{2}\end{matrix} \} = IncrSVD \begin{matrix}\{ {U}_{1} , & \frac{1}{{N}_{d} + 1} {S}_{1} , & {V}_{1} , & - μ {\vert}_{{N}_{d} + 1} , & μ {\vert}_{{N}_{d} + 1} \}\end{matrix} \\ wherein \\ {U}_{2} {S}_{2} {V}_{2}^{T} = Σ {\vert}_{{N}_{d} + 1}\end{matrix} \qquad ( 26 )$$

As described above, a data update technique when the number of pieces of data is increased from N_{d} to N_{d}+1 by one has been clarified on the basis of FIG. 3, but the present disclosed technology is not limited thereto. For example, the data processing device 100 according to the present disclosed technology may divide data into a plurality of batches in advance and update the data in units of batches. The technique of updating data in units of batches is the same as the technique of sequentially increasing the number of pieces of data one by one. That is, even in a case where the number of pieces of data is updated in units of batches, the SVD of the gram matrix may be updated using the first IncrSVD( ), and the SVD of the variance-covariance matrix (Σ) may be obtained from the SVD of the correlation matrix using the second IncrSVD( ).

### (Mahalanobis Distance Using Rank-Constrained General Inverse Matrix)

As shown in Mathematical Formula (6), the variance-covariance matrix (Σ) is a positive-semidefinite matrix. When the variance-covariance matrix (Σ) is not full-rank, there is no inverse matrix (Σ⁻¹) of the variance-covariance matrix (Σ). Even in a case where the variance-covariance matrix (Σ) is full rank in numerical calculation, in a case where any of the singular values of the variance-covariance matrix (Σ) is close to zero, so-called zero division occurs numerically. In addition, the problem of the apparent full rank due to the numerical error is as described in Introduction 3.

In preparation for such a case, the Mahalanobis distance may be obtained by lowering the dimension of the feature space within the range of tolerance.

The data processing device 100 according to the present disclosed technology intentionally lowers the rank of the variance-covariance matrix (Σ) to k (k≤r). When the number of pieces of data is Na, a value obtained by lowering the rank of the variance-covariance matrix to k is given by the following mathematical formula.

$$\begin{matrix}Σ {\vert}_{{N}_{d}} \sim {\overbrace{{( Σ {\vert}_{{N}_{d}} )}_{k}}}^{∈ {ℝ}^{{N}_{f} \times {N}_{f}}} = {\overbrace{U {\vert}_{{N}_{d}}}}^{∈ {ℝ}^{{N}_{f} \times {N}_{f}}} {\overbrace{[ \begin{matrix}{σ}_{1}^{2} & & & & & \\ & ⋱ & & & & \\ & & {σ}_{k}^{2} & & & \\ & & & 0 & & \\ & & & & ⋱ & \\ & & & & & 0\end{matrix} ]}}^{∈ {ℝ}^{{N}_{f} \times {N}_{f}}} \\ = {\overbrace{\begin{matrix}[ {u}_{1} , & … & {u}_{k} ]\end{matrix}}}^{{( U )}_{k} ∈ {ℝ}^{{N}_{f} \times k}} {\overbrace{[ \begin{matrix}{σ}_{1}^{2} & & \\ & ⋱ & \\ & & {σ}_{k}^{2}\end{matrix} ]}}^{{( {S}^{2} )}_{k} ∈ {ℝ}^{k \times K}} {\overbrace{[ \begin{matrix}{u}_{1}^{T} \\ ⋮ \\ {u}_{k}^{T}\end{matrix} ]}}^{{( U )}_{k}^{T} ∈ {ℝ}^{k \times {N}_{f}}}\end{matrix} {\overbrace{{U}^{T} {\vert}_{{N}_{d}}}}^{∈ {ℝ}^{{N}_{f} \times {N}_{f}}} \qquad ( 27 )$$

$$\begin{matrix}wherein \\ k \leq r\end{matrix}$$

“(⋅)ₖ” appearing in Mathematical Formula (27) represents an approximation in which the rank is reduced to k in dimension. At this time, the error due to the lowering of the rank of the variance-covariance matrix (Σ) can be evaluated as follows.

$$‖ {( Σ {\vert}_{{N}_{d}} )}_{k} - Σ {\vert}_{{N}_{d}} ‖ = \sqrt{{σ}_{k + 1}^{4} + … + {σ}_{{N}_{f}}^{4}} \qquad ( 28 )$$

Finally, the Mahalanobis distance when the rank is k (k≤r) is given as follows.

$${( {d}_{M}^{2} )}_{k} = {\overbrace{{( {x}_{target} - μ {\vert}_{{N}_{d}} )}^{T}}}^{{y}_{target}^{T}} {\overbrace{{( U )}_{k} {( {S}^{2} )}_{k}^{- 1} {( U )}_{k}^{T}}}^{{( Σ {\vert}_{{N}_{d}} )}_{k}^{- 1}} {\overbrace{( {x}_{target} - μ {\vert}_{{N}_{d}} )}}^{{y}_{target}} \qquad ( 29 )$$

As described above, the data processing method according to the present disclosed technology has high affinity with the low ranking approximation based on singular value decomposition in the learning phase, and thus can benefit from the low ranking approximation that can reduce the number of parameters that need to be stored. However, in a case where the Mahalanobis distance of a subspace reduced in dimension in the inference phase is obtained, it is important that the subspace is a space projected by what kind of projection matrix and how many dimensions the subspace has. The reason why this is important will become clear from the description of the “zero singular value having meaning” described in a fifth embodiment.

The data processing device 100 according to the present disclosed technology outputs the following data in combination with the calculated Mahalanobis distance.

$$output data : \{ \begin{matrix}{( {d}_{M} )}_{k} or {( {d}_{M}^{2} )}_{k} , & {( U )}_{k} , & {( {S}^{2} )}_{k} or {( {S}^{2} )}_{k}^{- 1} \}\end{matrix} \qquad ( 30 )$$

That is, the data processing device 100 according to the present disclosed technology outputs the calculated Mahalanobis distance, and the singular vector and the singular value related to the variance-covariance matrix (Σ).

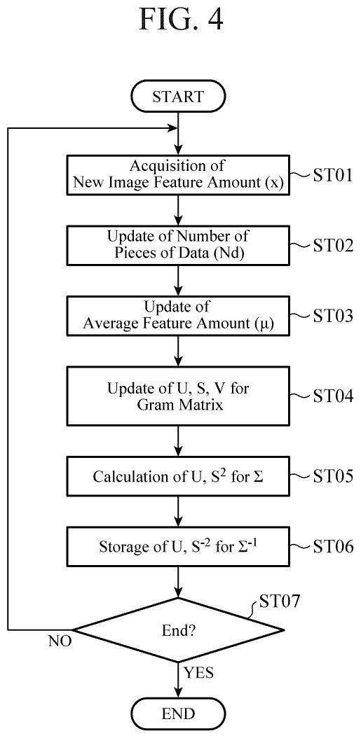

FIG. 4 is a first flowchart illustrating a processing step in parameter update of the data processing device 100 according to the first embodiment. As illustrated in FIG. 4, the processing steps of the data processing device 100 according to the first embodiment can be divided into ST01 to ST07.

The processing step (ST01) described as “acquisition of a new image feature amount (x)” is a processing step performed via the input interface 110. In ST01, the data processing device 100 acquires, for example, N_{d}+1th data x_{Nd+1} via the input interface 110.

A processing step (ST02) described as “update of the number of pieces of data (N_{d})” is a processing step performed by the processing circuit 120 or the processor 122.

In ST02, the processing circuit 120 or the processor 122 updates the count of the number of pieces of data from N_{d} to N_{d}+1, for example.

A processing step (ST03) described as “update of average feature amount (μ)” is a processing step performed by the processing circuit 120 or the processor 122. In ST03, the processing circuit 120 or the processor 122 performs “update of the average feature amount” indicated in Mathematical Formula (25).

A processing step (ST04) described as “U, S, V update for gram matrix” is a processing step performed by the processing circuit 120 or the processor 122. In ST04, the processing circuit 120 or the processor 122 updates the SVD for the gram matrix using the first IncrSVD( ) expressed in Mathematical Formula (23).

A processing step (ST05) described as “calculation of U and S² for Σ” is a processing step performed by the processing circuit 120 or the processor 122. In ST05, the processing circuit 120 or the processor 122 calculates the SVD of the variance-covariance matrix (Σ) when the number of pieces of data is N_{d}+1 by using the second IncrSVD( ) expressed by Mathematical Formula (26).

The processing step (ST06) described as “storage of U and S⁻² for Σ⁻¹” is a processing step performed using the memory 124 or an external storage device. In ST06, the data processing device 100 stores the singular vector (U) and the singular value (S⁻²) for the latest Σ⁻¹ in the memory 124 or the external storage device.

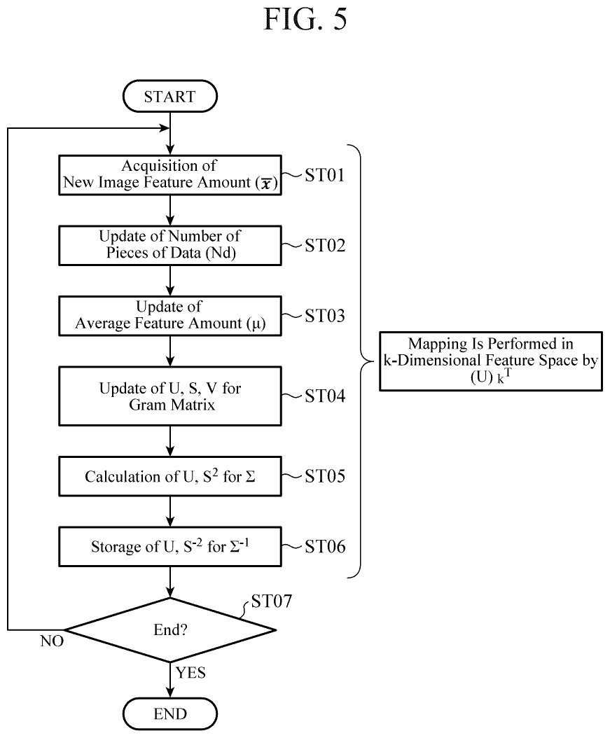

FIG. 5 is a second flowchart illustrating processing steps in parameter update of the data processing device 100 according to the first embodiment.

The processing steps shown in FIG. 5 are the same as the processing steps shown in FIG. 4. However, as illustrated in FIG. 5, the processing step illustrated in FIG. 5 uses a k-dimensional feature space mapped by a fixed (U)ₖ^{T}. The image feature amount (x attached with an accent mark of a bar) handled by the flowchart illustrated in FIG. 5 is given by the following mathematical formula.

$$for c = 1 to {N}_{d} \qquad ( 31 )$$

$${\overbrace{\overline{{x}_{c}}}}^{∈ {ℝ}^{k \times 1}} := {\overbrace{[ \begin{matrix}{u}_{1}^{T} \\ ⋮ \\ {u}_{k}^{T}\end{matrix} ]}}^{{( U )}_{k}^{T} ∈ {ℝ}^{k \times {N}_{f}}} {\overbrace{{x}_{c}}}^{∈ {ℝ}^{{N}_{f} \times 1}}$$

However, (U)ₖ^{T} appearing in Mathematical Formula (31) is an empirically obtained matrix, and performs mapping from the N_{f}-dimensional space to the k-dimensional space.

(U)ₖ^{T} may be a matrix including 1st to k-th right singular vectors with respect to the variance-covariance matrix (Σ) when the data is sufficiently rich, i.e. contains sufficient information to reproduce the properties of the class to which the data belongs (see Mathematical Formula (27)). A technique for determining whether or not the data is sufficiently rich is clear from the description of a sixth embodiment.

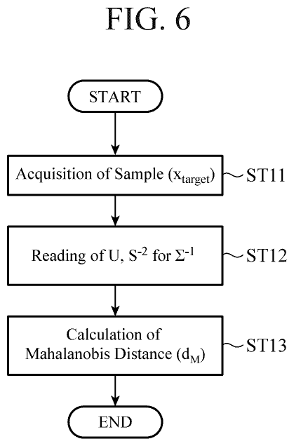

FIG. 6 is a flowchart illustrating processing steps in distance calculation of the data processing device 100 according to the first embodiment. While FIGS. 4 and 5 illustrate processing steps performed in the learning phase of the data processing device 100, FIG. 6 illustrates processing steps performed in the inference phase of the data processing device 100. As illustrated in FIG. 6, the processing step in the inference phase can be divided into ST11 to ST13.

Note that, although not particularly illustrated, the data processing device 100 in the learning phase and the data processing device 100 in the inference phase may be different devices. That is, there may be a data processing device 100 that performs inference separately from the data processing device 100 that performs learning.

The processing step (ST11) described as “acquisition of sample (x_{target})” is a processing step performed by the data processing device 100 that performs inference. In ST11, the data processing device 100 that performs inference acquires x_{target} that is an image feature amount for which the Mahalanobis distance is desired to be obtained.

A processing step (ST12) described as “Reading U and S⁻² for Σ⁻¹” is a processing step performed by the data processing device 100 that performs inference. In ST12, the data processing device 100 that performs inference reads U and S⁻² for Σ⁻¹ stored in ST06 of the learning phase.

A processing step (ST13) described as “calculation of the Mahalanobis distance (d_{M})” is a processing step performed by the data processing device 100 that performs inference. The data processing device 100 that performs inference calculates the Mahalanobis distance (d_{M}) or the square (d_{M}²) of the Mahalanobis distance (See Mathematical Formulas (7), (21), and (29)).

In order to clarify the feature space in which the calculated Mahalanobis distance is defined, the data processing device 100 that performs inference outputs the data indicated in Mathematical Formula (30), that is, (U)ₖ and (S²)ₖ or (S⁻²)ₖ together with the calculated Mahalanobis distance.

### (Simple Numerical Example)

The data processing method according to the present disclosed technology will be further clarified by the following simple numerical examples. It is assumed that data belonging to a certain class is given as follows.

$$\begin{matrix}X {\vert}_{3} = [ \begin{matrix}121 & 110 & 119 \\ 31 & 40 & 29\end{matrix} ] \\ {x}_{4} = [ \begin{matrix}130 \\ 20\end{matrix} ]\end{matrix} \qquad ( 32 )$$

The numerical example shown in Mathematical Formula (32) is a case where the number of pieces of data (N_{d}) is increased from 3 to 4.

It is assumed that the average feature amount and the SVD of the gram matrix when the number of pieces of data is 3 are given as follows.

$$\begin{matrix}μ {\vert}_{3} = \frac{1}{3} ( [ \begin{matrix}121 \\ 31\end{matrix} ] + [ \begin{matrix}110 \\ 40\end{matrix} ] + [ \begin{matrix}119 \\ 29\end{matrix} ] ) = [ \begin{matrix}116.6667 \\ 33.33333\end{matrix} ] \\ X {\vert}_{3} {X}^{T} {\vert}_{3} = [ \begin{matrix}121 & 110 & 119 \\ 31 & 40 & 29\end{matrix} ] [ \begin{matrix}121 & 31 \\ 110 & 40 \\ 119 & 29\end{matrix} ] \\ = [ \begin{matrix}40902 & 11602 \\ 11602 & 3402\end{matrix} ] \\ = {\overbrace{[ \begin{matrix}- 0.9618652 & + 0.2735238 \\ - 0.2735238 & - 0.9618652\end{matrix} ]}}^{{U}_{0}} {\overbrace{[ \begin{matrix}44 , 201.24 & 0 \\ 0 & 102.7618\end{matrix} ]}}^{{S}_{0}} {\overbrace{[ \begin{matrix}- 0.9618652 & - 0.2735238 \\ + 0.2735238 & - 0.9618652\end{matrix} ]}}^{{V}_{0}^{T}}\end{matrix} \qquad ( 33 )$$

Note that the numerical examples in this specification are displayed up to seven digits due to limitations on the paper surface.

The first IncrSVD( ) updates the SVD of the gram matrix.

$$\begin{matrix}\begin{matrix}\{ {U}_{1} , & {S}_{1} , & {V}_{1} \}\end{matrix} = IncrSVD \begin{matrix}\{ {U}_{0} , & {S}_{0 ,} & {V}_{0} , & {x}_{4} , & {x}_{4} \}\end{matrix} \\ wherein \\ {U}_{1} = [ \begin{matrix}- 0.970833 & + 0.2397568 \\ - 0.2397568 & - 0.970833\end{matrix} ] \\ {S}_{1} = [ \begin{matrix}61 , 309.32 & 0 \\ 0 & 294.6762\end{matrix} ] \\ {V}_{1}^{T} = [ \begin{matrix}- 0.970833 & + 0.2397568 \\ - 0.2397568 & - 0.970833\end{matrix} ]\end{matrix} \qquad ( 34 )$$

As shown in Mathematical Formula (34), the left singular vector and the right singular vector coincide with each other due to symmetry of the gram matrix.

The SVD obtained by the first IncrSVD( ) is the SVD of the gram matrix when the number of pieces of data is 4.

$$\begin{matrix}{U}_{1} {S}_{1} {V}_{1}^{T} = [ \begin{matrix}57802 & 14202 \\ 14202 & 3802\end{matrix} ] \\ wherein \\ X {\vert}_{4} {X}^{T} {\vert}_{4} = [ \begin{matrix}121 & 110 & 119 & 130 \\ 31 & 40 & 29 & 20\end{matrix} ] [ \begin{matrix}121 & 31 \\ 110 & 40 \\ 119 & 29 \\ 130 & 20\end{matrix} ] \\ = [ \begin{matrix}57802 & 14202 \\ 14202 & 3802\end{matrix} ]\end{matrix} \qquad ( 35 )$$

The average feature amount is updated as follows.

$$\begin{matrix}μ {\vert}_{4} = \frac{1}{4} ( 3 [ \begin{matrix}116.6667 \\ 33.33333\end{matrix} ] + [ \begin{matrix}130 \\ 20\end{matrix} ] ) \\ = [ \begin{matrix}120 \\ 30\end{matrix} ]\end{matrix} \qquad ( 36 )$$

By the second IncrSVD( ) the SVD of the variance-covariance matrix (Σ) is obtained as follows.

$$\begin{matrix}\{ \begin{matrix}{U}_{2} , & {S}_{2} , & {V}_{2}\end{matrix} \} = IncrSVD \{ \begin{matrix}{U}_{1} , & \frac{1}{4} {S}_{1 ,} & {V}_{1} , & - μ {\vert}_{4} , & μ {\vert}_{4} \}\end{matrix} \\ wherein \\ {U}_{2} = [ \begin{matrix}+ 0.7071068 & - 0.7071068 \\ - 0.7071068 & - 0.7071068\end{matrix} ] \\ {S}_{2} = [ \begin{matrix}100 & 0 \\ 0 & 1\end{matrix} ] \\ {V}_{2}^{T} = [ \begin{matrix}+ 0.7071068 & - 0.7071068 \\ - 0.7071068 & - 0.7071068\end{matrix} ]\end{matrix} \qquad ( 37 )$$

The SVD obtained by the second IncrSVD( ) is the SVD of the variance-covariance matrix (Σ) when the number of pieces of data is 4.

$$\begin{matrix}{U}_{2} {S}_{2} {V}_{2}^{T} = [ \begin{matrix}+ 50.5 & - 49.5 \\ - 49.5 & + 50.5\end{matrix} ] \\ wherein \\ Σ {\vert}_{4} = \frac{1}{4} [ \begin{matrix}+ 1 & - 10 & - 1 & + 10 \\ + 1 & + 10 & - 1 & - 10\end{matrix} ] [ \begin{matrix}+ 1 & + 1 \\ - 10 & + 10 \\ - 1 & - 1 \\ + 10 & - 10\end{matrix} ] \\ = \frac{1}{4} [ \begin{matrix}+ 202 & - 198 \\ - 198 & + 202\end{matrix} ] = {\overbrace{[ \begin{matrix}+ 50.5 & - 49.5 \\ - 49.5 & + 50.5\end{matrix} ]}}^{+ {U}_{2} {S}_{2} {V}_{2}^{T}}\end{matrix} \qquad ( 38 )$$

A technical feature of the data processing device and the data processing method according to the first embodiment is that an algorithm for updating a variance-covariance matrix (Σ) in a learning phase has affinity with singular value decomposition. More specifically, the data processing device and the data processing method according to the first embodiment include a function having affinity with singular value decomposition called IncrSVD( ) in an algorithm for updating a variance-covariance matrix (Σ) in a learning phase.

With this technical feature, the data processing device and the data processing method according to the first embodiment can benefit from the singular value decomposition that can cope with the problem of apparent full-rank due to numerical errors (see Introduction 3).

A technical feature of the data processing device and the data processing method according to the first embodiment is that an algorithm for updating a variance-covariance matrix (Σ) in a learning phase has affinity with the low ranking approximation based on singular value decomposition. More specifically, the data processing device and the data processing method according to the first embodiment include a function having affinity with the low ranking approximation based on the singular value decomposition of IncrSVD( ) in the algorithm for updating the variance-covariance matrix (Σ) in the learning phase.

With this technical feature, the data processing device and the data processing method according to the first embodiment can benefit from the low ranking approximation based on the singular value decomposition that the information can be slimmed to a necessary amount in the learning phase.

The data processing device and the data processing method according to the first embodiment are applied to abnormality detection using PaDiM, and the effects thereof are verified. In this application, the image is divided into 56×56 small regions. For each small region, the variance-covariance matrix (Σ) is updated. As described in Non-Patent Literature 1 related to PaDiM, Wide ResNet50 is used for CNN, and the length (N_{f}) of the feature amount is 1792 in the generated image feature amount. Even with simple calculation, the memory required for updating in the learning phase is 56×56×1792×1792-40 [GB]. Even in consideration of the fact that the variance-covariance matrix (Σ) is a symmetric matrix, a memory of about 20 [GB] is still required.

The data processing device and the data processing method according to the first embodiment have demonstrated that the dimension of update in the learning phase can be reduced to k=20 in this application example.

### Second Embodiment

A data processing device and a data processing method according to a second embodiment are modifications of the data processing device and the data processing method according to the present disclosed technology. In the second embodiment, the same reference numerals as those in the first embodiment are used unless otherwise distinguished. In addition, in the second embodiment, the description overlapping with the first embodiment is appropriately omitted.

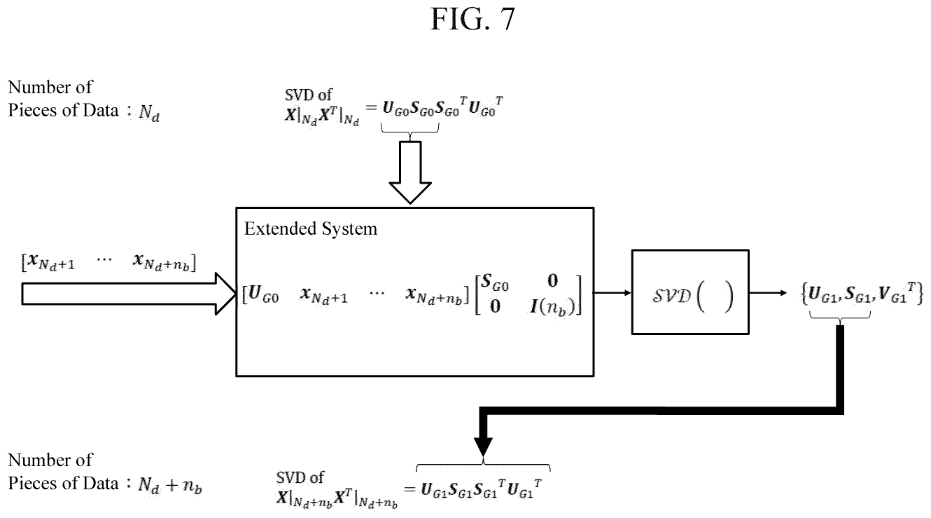

In order to distinguish from the technique described in the first embodiment, in the present specification, the data processing method according to the second embodiment is referred to as “IncrPCA”. FIG. 7 is an explanatory diagram illustrating the data processing method according to the second embodiment.

By the way, a core idea of IncrSVD( ) is to introduce the following extended system.

$$Z + {AB}^{T} = [ \begin{matrix}U & A\end{matrix} ] [ \begin{matrix}S & 0 \\ 0 & I\end{matrix} ] [ \begin{matrix}{V}^{T} \\ {B}^{T}\end{matrix} ] \qquad ( 39 )$$

The technique of introducing the extended system is also effective for cases handled by the present disclosed technology. It is assumed that the SVD of the gram matrix is given as in Mathematical Formula (22) when the number of pieces of data is N_{d}. However, considering that the gram matrix is a positive-semidefinite matrix expressed in a quadratic form, the SVD of the gram matrix can be expressed as follows.

$${X {\vert}_{{N}_{d}} {X}^{T} \vert}_{{N}_{d}} = {\overbrace{{U}_{G 0}}}^{{U}_{0}} {\overbrace{{S}_{G 0} {{S}_{G 0}}^{T}}}^{{S}_{0}} {\overbrace{{{U}_{G 0}}^{T}}}^{{V}_{0}^{T}} \qquad ( 40 )$$

Note that the low ranking approximation may be performed on the SVD of the gram matrix. The condition under which the low ranking approximation can be performed is clear from the fifth embodiment.

When obtaining the N_{d}+1th data, the gram matrix can be represented by the following extended system.

$${{X {\vert}_{{N}_{d}} {X}^{T} \vert}_{{N}_{d}} + {x}_{{N}_{d} + 1} {{x}_{{N}_{d} + 1}}^{T} = [ \begin{matrix}{U}_{G 0} & {x}_{{N}_{d} + 1}\end{matrix} ] [ \begin{matrix}{S}_{G 0} & 0 \\ 0 & 1\end{matrix} ] [ \begin{matrix}{{S}_{G 0}}^{T} & 0 \\ 0 & 1\end{matrix} ] [ \begin{matrix}{{U}_{G 0}}^{T} \\ {{x}_{{N}_{d} + 1}}^{T}\end{matrix} ] = X {\vert}_{{N}_{d} + 1} {X}^{T} \vert}_{{N}_{d} + 1} \qquad ( 41 )$$

Mathematical Formula (41) suggests the following.

$$𝒮𝒱𝒟 \{ [ \begin{matrix}{U}_{G 0} & {x}_{{N}_{d} + 1}\end{matrix} ] [ \begin{matrix}{S}_{G 0} & 0 \\ 0 & 1\end{matrix} ] \} = 𝒮𝒱𝒟 \{ X {\vert}_{{N}_{d} + 1} \} \qquad ( 42 )$$

Here, “SVD” of the script typeface appearing in Mathematical Formula (42) represents a function for obtaining singular value decomposition.

As described above, the data update technique when the number of pieces of data is increased from N_{d} to N_{d}+1 by one has been clarified by introducing an extended system, but the present disclosed technology is not limited thereto. For example, the data processing device 100 according to the present disclosed technology may divide data into a plurality of batches in advance, add data in units of batches, and create an extended system. The technique of introducing the extended system in units of batches is the same idea as the technique of sequentially increasing data one by one.

The batch processing is equivalent to a situation in which n_{b} pieces of data are newly added together when the number of pieces of data is N_{d}. When such data processing is performed, Mathematical Formula (42) is rewritten as follows.

$${𝒮𝒱𝒟 \{ {\overbrace{[ \begin{matrix}{U}_{G 0} & {x}_{{N}_{d} + 1} & ⋯ & {N}_{{N}_{d} + {n}_{b}}\end{matrix} ]}}^{∈ {ℝ}^{{N}_{f} \times ( {N}_{f} + {n}_{b} )}} {\overbrace{[ \begin{matrix}{S}_{G 0} & 0 \\ 0 & I ( {n}_{b} )\end{matrix} ]}}^{∈ {ℝ}^{( {N}_{f} + {n}_{b} ) / ( {N}_{f} + {n}_{b} )}} \} = 𝒮𝒱𝒟 \{ X \vert}_{{N}_{d} + {n}_{b}} \} \qquad ( 43 )$$

Here, I(n_{b}) appearing in Mathematical Formula (43) is a unit matrix having a size of n_{b}×n_{b}.

As described above, the low ranking approximation may be performed on the SVD of the gram matrix to the k (k<r) dimension. The fact that the low ranking approximation is performed to the k dimension means that only the top k singular values arranged in descending order are used among the singular values of the gram matrix (for example, see Mathematical Formula (27)). However, since the updating of the gram matrix is loop processing, the error caused by the low ranking approximation is cumulative.

In the abnormality detection processing by PaDiM, the inventor of the present disclosed technology has reduced the original dimension of N_{f}=1792 to k=20 and has updated the gram matrix by loop processing. In this application example, the inventor of the present disclosed technology has found that this cumulative error is within an allowable range.

### (Simple Numerical Example)

By using the same numerical examples as those shown in the first embodiment, the data processing method according to the second embodiment is further clarified. When the number of pieces of data is three, U_{G0} and S_{G0} of the gram matrix are given as follows.

$${U}_{G 0} = [ \begin{matrix}- 0.9618652 & + 0.2735238 \\ - 0.2735238 & - 0.9618652\end{matrix} ] \qquad ( 44 )$$

$${S}_{G 0} = [ \begin{matrix}+ 210.2409 & 0 \\ 0 & + 10.13715\end{matrix} ]$$

Note that U_{G0} is the same as U₀.

By applying the numerical example, Mathematical Formula (42) is calculated as follows.

$$[ \begin{matrix}{U}_{G 0} & {x}_{4}\end{matrix} ] [ \begin{matrix}{S}_{G 0} & 0 \\ 0 & 1\end{matrix} ] = [ \begin{matrix}- 0.9618652 & + 0.2735238 & 130 \\ - 0.2735238 & - 0.9618652 & 20\end{matrix} ] [ \begin{matrix}+ 210.2409 & 0 & 0 \\ 0 & + 10.13715 & 0 \\ 0 & 0 & 1\end{matrix} ] = [ \begin{matrix}- 202.2234 & + 2.772752 & 130 \\ - 57.50588 & - 9.750573 & 20\end{matrix} ] \qquad ( 45 )$$

Further, the matrix calculated by Mathematical Formula (45) can be expressed in the following SVD format.

$$𝒮𝒱𝒟 \{ [ \begin{matrix}- 202.2234 & + 2.772752 & 130 \\ - 57.50588 & - 9.750573 & 20\end{matrix} ] \} = {U}_{3} {S}_{3} {{V}_{3}}^{T} = 𝒮𝒱𝒟 \{ X {\vert}_{4} \} \qquad ( 46 )$$

$$wherein$$

$${U}_{3} = [ \begin{matrix}- 0.970833 & - 0.2397568 & 0 \\ - 0.2397568 & + 0.970833 & 0\end{matrix} ] = [ \begin{matrix}{U}_{1} & 0\end{matrix} ]$$

$${S}_{3} = [ \begin{matrix}+ 247.6072 & 0 & 0 \\ 0 & + 17.16614 & 0 \\ 0 & 0 & + 0\end{matrix} ] = [ \begin{matrix}{{S}_{1}}^{0.5} & \\ & 0\end{matrix} ]$$

$${{V}_{3}}^{T} = [ \begin{matrix}+ 0.8485722 & - 0.0014301 & - 0.5290776 \\ - 0.4278291 & - 0.5901715 & - 0.6845874 \\ - 0.3112675 & + 0.8072766 & - 0.501415\end{matrix} ]$$

Here, the subscript “3” appearing in Mathematical Formula (46) is simply a number for identifying which matrix the SVD is for.

The first singular vector and the second singular vector of U₃ calculated by Mathematical Formula (46) are the same as the first singular vector and the second singular vector of U₁ calculated by Mathematical Formula (34). Further, when squared, the first singular value and the second singular value of S₃ calculated by Mathematical Formula (46) respectively coincide with the first singular value and the second singular value of S₁ calculated by Mathematical Formula (34).

$$\begin{matrix}{X {\vert}_{4} {X}^{T} \vert}_{4} = ( {U}_{3} {{S}_{3}}^{2} {{V}_{3}}^{T} ) {( {U}_{3} {{S}_{3}}^{2} {{U}_{3}}^{T} )}^{T} \\ = {U}_{3} {{S}_{3}}^{2} {{U}_{3}}^{T} \\ = [ \begin{matrix}{U}_{1} & 0\end{matrix} ] [ \begin{matrix}{{S}_{1}}^{0.5} & \\ & 0\end{matrix} ] [ \begin{matrix}{{U}_{1}}^{T} \\ {0}^{T}\end{matrix} ] \\ = {U}_{1} {S}_{1} {{U}_{1}}^{T}\end{matrix} \qquad ( 47 )$$

As illustrated in Mathematical Formula (47), the data processing device according to the second embodiment extends the dimension of the matrix to (N_{f}+n_{b})× (N_{f}+n_{b}), but no singular values become 0 in the SVD of the gram matrix, and thus, a decomposition form having a size of N_{f}×N_{f} is finally obtained.

Processing steps in the data processing method of Mathematical Formula (47) and subsequent expressions are the same as those in the data processing method according to the first embodiment.

A technical feature unique to the data processing device and the data processing method according to the second embodiment is that an algorithm for introducing an extended system and updating a gram matrix in a learning phase is included.

With this technical feature, the data processing device and the data processing method according to the second embodiment have also an effect of being able to be implemented by using a general-purpose SVD function instead of IncrSVD( ) in addition to the effect described in the first embodiment.

### Third Embodiment

A data processing device and a data processing method according to a third embodiment are modifications of the data processing device and the data processing method according to the present disclosed technology. In the third embodiment, the same reference numerals as those used in the previously described embodiments are used unless otherwise specified. In addition, in the third embodiment, the description overlapping with the previously described embodiments is appropriately omitted.

In order to distinguish from the methods described in the previously described embodiments, in the present specification, the data processing method according to the third embodiment is referred to as “GPU-oriented IncrPCA”.

The data processing device according to the present disclosed technology may use a graphics processing unit (GPU) instead of a central processing unit (CPU). An advantage of using a GPU is that a function for determining SVD (hereinafter, simply referred to as an “SVD function”) is already prepared as a library (for example, the library of cuSOLVER of NVidia). The GPU-based SVD function is fast if the size of the matrix is 32×32 or less.

The scene assumed by the third embodiment is a scene in which, for example, even if the low ranking approximation is performed to k=32 or less, the error is sufficiently small to be negligible. However, in order to facilitate understanding of the data processing method according to the third embodiment, in the present specification, first, a mathematical formula without performing the low ranking approximation is described.

### (Prior Knowledge of Data Processing Method According to Third Embodiment)

The singular value decomposition of any matrix (Z) can be obtained by the eigenvalue decomposition of Z^{T}Z and the eigenvalue decomposition of ZZ^{T}. It is assumed that the form of singular value decomposition of Z is USV^{T}. Z^{T}Z can be deformed as follows.

$$\begin{matrix}{Z}^{T} Z = ( {USV}^{T} ) ( {USV}^{T} ) \\ = {VS}^{T} {SV}^{T}\end{matrix} \qquad ( 48 )$$

$$therefore$$

$${Z}^{T} ZV = {VS}^{T} S$$

Here, if the i-th column of V is vᵢ, the following relationship is obtained from Mathematical Formula (48).

$$( {Z}^{T} Z ) {v}_{i} = {{σ}_{i}}^{2} {v}_{i} \qquad ( 49 )$$

That is, vᵢ and σᵢ² are eigenvectors and eigenvalues of Z^{T}Z, respectively.

Similarly, ZZ^{T} can be deformed as follows.

$$\begin{matrix}{ZZ}^{T} = ( {USV}^{T} ) ( {USV}^{T} ) \\ = {USS}^{T} {U}^{T}\end{matrix} \qquad ( 50 )$$

$$therefore$$

$${ZZ}^{T} U = {USS}^{T}$$

Here, if the i-th column of U is ui, the following relationship is obtained from Mathematical Formula (50).

$$( {ZZ}^{T} ) {u}_{i} = {{σ}_{i}}^{2} {u}_{i} \qquad ( 51 )$$

As described above, the singular value decomposition of any matrix (Z) can be obtained by the eigenvalue decomposition of Z^{T}Z and the eigenvalue decomposition of ZZ^{T}.

For example, it is assumed that the size of Z is p×q and a matrix is horizontally long, that is, q>p. In this case, the size of Z^{T}Z is small at p×p, but the size of ZZ^{T} is large at q×q. In such a case, only the eigenvalue decomposition of Z^{T}Z may be performed to calculate the matrix (V) related to the right singular vector and the matrix(S) related to the singular value. The matrix (U) related to the left singular vector may be calculated by the following calculation.

$$when {S}^{- 1} exists \qquad ( 52 )$$

$$U = {ZVS}^{- 1}$$

$$because$$

$$Z = {USV}^{T}$$

Here, if the low ranking approximation is performed to the k (k<r) dimension, all the assumed k singular values are non-zero, and it is possible to ensure that S⁻¹ exists. In the eigenvalue decomposition of Z^{T}Z, if there is no non-zero eigenvalue, S⁻¹ can be calculated without performing the low ranking approximation.

### (Details of Data Processing Method According to Third Embodiment)

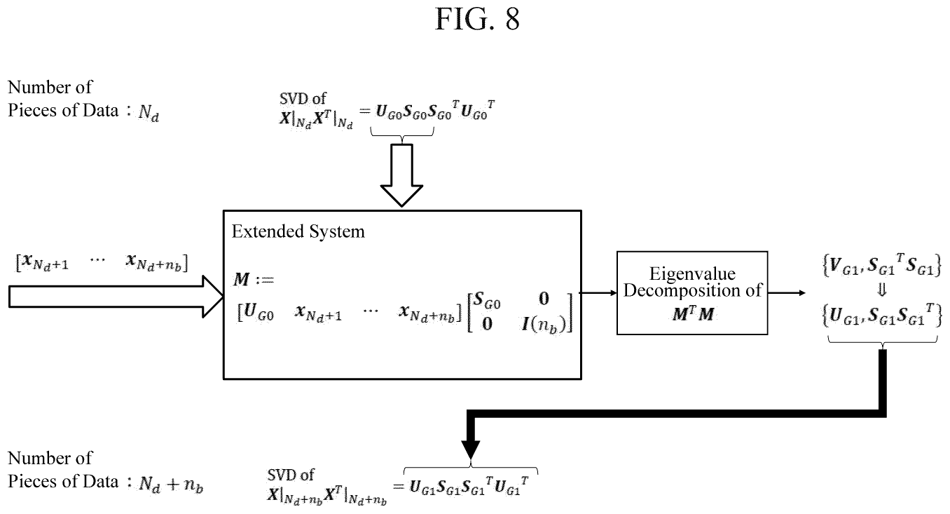

FIG. 8 is an explanatory diagram illustrating a data processing method according to the third embodiment.

In the data processing device according to the third embodiment, the following matrix appearing in Mathematical Formula (43) is defined as M.

$$M \vert {N}_{d} + {n}_{b} := {\overbrace{[ \begin{matrix}{U}_{G 0} & {x}_{{N}_{d} + 1} & ⋯ & {x}_{{N}_{d} + {n}_{b}}\end{matrix} ] [ \begin{matrix}{S}_{G 0} & 0 \\ 0 & I ( {n}_{b} )\end{matrix} ]}}^{∈ {ℝ}^{{N}_{f} \times ( {N}_{f} + {n}_{b} )}} \text{=:} [ \begin{matrix}{U}_{G 0} & {X}_{b}\end{matrix} ] [ \begin{matrix}{S}_{G 0} & 0 \\ 0 & I ( {n}_{b} )\end{matrix} ] \qquad ( 53 )$$

$$wherein$$

$${X}_{b} := [ \begin{matrix}{x}_{{N}_{d} + 1} & ⋯ & {x}_{{N}_{d} + {n}_{b}}\end{matrix} ]$$

Note that M is a matrix (X) including data in which the number of pieces of data is up to N_{d}+n_{b}. A lower right subscript b for X is a serial number assigned to each batch. The number of pieces of data in the b-th batch is n_{b}.

M can be SVD as follows.

$${M \vert}_{{N}_{d} + {n}_{b}} = {\overbrace{{U}_{G 1}}}^{∈ {ℝ}^{{N}_{f} \times {N}_{f}}} {\overbrace{{S}_{G 1}}}^{∈ {ℝ}^{{N}_{f} \times {N}_{f}}} {\overbrace{{V}_{G 1}^{T}}}^{∈ {ℝ}^{{N}_{f} \times ( {N}_{f} + {n}_{b} )}} \qquad ( 54 )$$

However, at this stage, it is assumed that the SVD format has not yet been obtained. Note that the subscript “G1” appearing in Mathematical Formula (54) is simply a symbol for identifying which matrix the SVD is for.

The matrix (V_{G1}) related to the right singular vector and the matrix (S_{G1}) related to the singular value for M may be obtained by eigenvalue decomposition of the M^{T}M as shown in Mathematical Formulas (48) and (49).

Furthermore, the matrix (U_{G1}) regarding the left singular vector for Mis calculated from the following relational formula.

$$M {\vert}_{{N}_{d} + {n}_{b}} {V}_{G 1} = {U}_{G 1} {S}_{G 1} \qquad ( 55 )$$

When all the eigenvalues of the M^{T}M are non-zero, the matrix (S_{G1}) related to the singular value has an inverse matrix.

The data processing device according to the third embodiment updates M every time the number of pieces of data increases. The updated M is given as follows.

$$( 56 )$$

$$M {\vert}_{{N}_{d} + {n}_{b} + {n}_{b + 1}} = [ \begin{matrix}{U}_{G 1} & {x}_{{N}_{d} + {N}_{b} + 1} & … & {x}_{{N}_{d} + {N}_{b} + N} \text{?}\end{matrix} ] [ \begin{matrix}{S}_{G 1} & 0 \\ 0 & I ( {n}_{b + 1} )\end{matrix} ] = : [ \begin{matrix}{U}_{G 1} & {X}_{b + 1}\end{matrix} ] [ \begin{matrix}{S}_{G 1} & 0 \\ 0 & I ( {n}_{b + 1} )\end{matrix} ]$$

$$wherein$$

$${X}_{b + 1} := {\overbrace{[ \begin{matrix}{x}_{{N}_{d} + {n}_{b} + 1} & … & {x}_{{N}_{d} + {n}_{b} + {n}_{b + 1}} ]\end{matrix}}}^{∈ {ℝ}^{{N}_{f} \times {n}_{b + 1}}}$$

$$\text{?} \text{indicates text missing or illegible when filed}$$

In Mathematical Formula (56), the number of pieces of data in the (b+1)-th batch is n_{b+1}.

The update of M illustrated in Mathematical Formula (56) corresponds to the update of the gram matrix using the first IncrSVD( ) in the first embodiment.

In singular value decomposition of M, low ranking approximation may be used. However, since the update of M is loop processing, the error caused by the low ranking approximation is cumulative. In the abnormality detection processing by PaDiM, the inventor of the present disclosed technology has reduced the original dimension of N_{f}=1792 to k=20 and has updated M by loop processing. In this application example, the inventor of the present disclosed technology has found that this cumulative error is within an allowable range.

The operation of obtaining the SVD of the variance-covariance matrix (Σ) from the SVD of the gram matrix after reflecting a sufficient number of pieces of data is also referred to as Finalization. At the stage of Finalization, the SVD of the gram matrix is determined as follows.

$${( X {\vert}_{{N}_{all}} )}_{k} = {( {U}_{G} {\vert}_{{N}_{all}} )}_{k} {\overbrace{{( {S}_{G} {\vert}_{{N}_{all}} )}_{k}}}^{∈ {ℝ}^{k \times k}} {( {V}_{G} {\vert}_{{N}_{all}} )}_{k}^{T} \qquad ( 57 )$$

The subscript “G” appearing in Mathematical Formula (57) is a symbol for emphasizing that it is the SVD of the gram matrix. Furthermore, as illustrated in Mathematical Formula (57), it is assumed that the SVD of the gram matrix is approximated by being reduced in dimension to the k dimension. Nₐₗₗ is the total number of pieces of data in Finalization.

In Finalization, the SVD of a variance-covariance matrix (Σ) is given as follows using an SVD function.

$$𝒮𝒱𝒟 \{ {( \sum {\vert}_{{N}_{all}} )}_{k} \} = 𝒮𝒱𝒟 \{ \frac{1}{{N}_{all}} {( {U}_{G} {\vert}_{{N}_{all}} )}_{k} {( {S}_{G} {\vert}_{{N}_{all}} )}_{k}^{2} {( {U}_{G} {\vert}_{{N}_{all}} )}_{k}^{T} - {( μ {\vert}_{{N}_{all}} )}_{k} {( μ {\vert}_{{N}_{all}} )}_{k}^{T} \} \qquad ( 58 )$$

However, the SVD illustrated in Mathematical Formula (58) also includes an error due to the approximation in reduced dimension. Furthermore, the average feature amount (μ) appearing on the right side of Mathematical Formula (58) is also reduced in dimension to the k dimension in consideration of the size of the matrix in addition and subtraction of the matrix. It can also be said that Mathematical Formula (58) gives SVD for a variance-covariance matrix (Σ) when the feature space is reduced in dimension to the k dimension. This SVD function may be a GPU-based SVD function.

A technical feature unique to the data processing device and the data processing method according to the third embodiment is that singular value decomposition of M is calculated on the basis of eigenvalue decomposition of M^{T}M.

With this technical feature, the data processing device and the data processing method according to the third embodiment have also an effect of being able to be implemented by a function for obtaining general-purpose eigenvalue decomposition in addition to the effects described in the above-described embodiments.

### Fourth Embodiment

A data processing device and a data processing method according to a fourth embodiment are modifications of the data processing device and the data processing method according to the present disclosed technology. In the fourth embodiment, the same reference numerals as those used in the above-described embodiments are used unless otherwise specified. In the fourth embodiment, the description overlapping with the previously described embodiment is appropriately omitted.

### (Verification Function)

The data processing device and the data processing method according to the present disclosed technology may include a verification function. The data processing device and the data processing method according to the present disclosed technology may obtain the correlation matrix for verification by the following sequential method other than the SVD format.

$$E {\overbrace{( {X}_{{N}_{d}} {X}^{T} {\vert}_{{N}_{d}} )}}^{∈ {ℝ}^{{N}_{f} \times {N}_{f}}} = \frac{1}{{N}_{d}} [ \begin{matrix}\begin{matrix}{x}_{1} & …\end{matrix} & {x}_{{N}_{d}}\end{matrix} ] [ \begin{matrix}\begin{matrix}{x}_{1}^{T} \\ ⋮\end{matrix} \\ {x}_{{N}_{d}^{T}}\end{matrix} ] \qquad ( 59 )$$

$$therefore$$

$$E ( {X}_{{N}_{d} + 1} {X}^{T} {\vert}_{{N}_{d} + 1} ) = \frac{{N}_{d}}{{N}_{d} + 1} E {\overbrace{( {X}_{{N}_{d}} {X}^{T} {\vert}_{{N}_{d}} )}}^{∈ {ℝ}^{{N}_{f} \times {N}_{f}}} + \frac{1}{{N}_{d} + 1} {\overbrace{{x}_{{N}_{d} + 1} {x}_{{N}_{d} + 1}^{T}}}^{∈ {ℝ}^{{N}_{f} \times {N}_{f}}}$$

The sequential update formula of the correlation matrix shown in Mathematical Formula (59) has the same form as the sequential update formula of the average feature amount (μ) shown in Mathematical Formula (25). By using E( ) of the expected value function, Mathematical Formula (25) is expressed as follows.

$$E ( X {\vert}_{{N}_{d} + 1} ) = \frac{{N}_{d}}{{N}_{d} + 1} E ( X {\vert}_{{N}_{d}} ) + \frac{1}{{N}_{d} + 1} {x}_{{N}_{d} + 1} \qquad ( 60 )$$

By using Mathematical Formulas (59) and (60), the variance-covariance matrix (Σ) for verification can be obtained by the following sequential method other than the SVD format.

$$E {\vert}_{{N}_{d} + 1} = E ( X {\vert}_{{N}_{d} + 1} {X}^{T} {\vert}_{{N}_{d} + 1} ) - E ( X {\vert}_{{N}_{d} + 1} ) {E ( X {\vert}_{{N}_{d} + 1} )}^{T} \qquad ( 61 )$$

$$wherein$$

$$E ( X {\vert}_{{N}_{d} + 1} {X}^{T} {\vert}_{{N}_{d} + 1} ) = \frac{{N}_{d}}{{N}_{d} + 1} E ( X {\vert}_{{N}_{d}} {X}^{T} {\vert}_{{N}_{d}} ) + \frac{1}{{N}_{d} + 1} {x}_{{N}_{d} + 1} {x}_{{N}_{d} + 1}^{T}$$

$$E ( X {\vert}_{{N}_{d} + 1} ) = \frac{{N}_{d}}{{N}_{d} + 1} E ( X {\vert}_{{N}_{d}} ) + \frac{1}{{N}_{d} + 1} {x}_{{N}_{d} + 1}$$

The updated variance-covariance matrix (Σ) obtained by Mathematical Formula (61) may be used to verify whether the format of the SVD obtained by the data processing method described in the above-described embodiments is correctly obtained.

A technical feature unique to the data processing device and the data processing method according to the fourth embodiment is that a correlation matrix for verification can be obtained directly and sequentially. The “directly” mentioned here means “not in the SVD format”.

With this technical feature, the data processing device and the data processing method according to the fourth embodiment have also an effect of being able to verify the correctness of the variance-covariance matrix (Σ) calculated in the SVD format in the learning phase, in addition to the effects described in the above-described embodiments.

### Fifth Embodiment

A data processing device and a data processing method according to a fifth embodiment are modifications of the data processing device and the data processing method according to the present disclosed technology. Unless otherwise specified, in the fifth embodiment, the same reference numerals as those used in the above-described embodiments are used. In the fifth embodiment, the description overlapping with the previously described embodiments is appropriately omitted.

Assuming that the variance-covariance matrix (Σ) after Finalization is the full rank, the square (d_{M}²) of the Mahalanobis distance for the target sample (x_{target}) is expressed as follows using the general inverse matrix (Σ⁻) (see also Mathematical Formula (21)).

$$\begin{matrix}{d}_{M}^{2} & = {y}_{target}^{T} {\overbrace{U {\vert}_{{N}_{all}} [ \begin{matrix}\frac{1}{{σ}_{1}^{2}} & & \\ & ⋱ & \\ & & \frac{1}{{σ}_{{N}_{f}}^{2}}\end{matrix} ] {U}^{T} {\vert}_{{N}_{all}} {y}_{target}}}^{{\sum }^{-}}\end{matrix} = : {\overline{y}}_{target}^{T} {\overline{y}}_{target} \qquad ( 62 )$$

$$wherein$$

$${y}_{target} = {x}_{target} - μ {\vert}_{{N}_{all}}$$

$${\overline{y}}_{target} := [ \begin{matrix}\frac{1}{{σ}_{1}} & & \\ & ⋱ & \\ & & \frac{1}{{σ}_{{N}_{f}}}\end{matrix} ] {U}^{T} {\vert}_{{N}_{all}} {y}_{target}$$

Here, the magnitude of the singular value is σ₁≥ . . . ≥σ_{Nf}. As described above, the Mahalanobis distance is obtained by the general inverse matrix (Σ) of the variance-covariance matrix (Σ), and in the general inverse matrix (Σ⁻), the first singular value (1/σ₁²) is the smallest, and the final singular value (1/σ_{Nf}²) is the largest. The fact that the final singular value (1/σ_{Nf}²) is the largest means that the term (component) for the final singular value (1/σ_{Nf}²) has the largest influence on the Mahalanobis distance.

In the learning phase, it can also be said that the variance-covariance matrix (Σ) representing the property of a certain class is important in the order of the magnitudes of the singular values, that is, in the order of σ₁, . . . , σ_{Nf}. Therefore, in the learning phase, the assumed feature space is a k-dimensional subspace, and there is no problem.

On the other hand, in the inference phase, it is important to make the feature space a full N_{f}-dimensional space.

### (Meaningful Zero Singular Value)

Even if the dimension of the space formed by all the deviation vectors (y₁, . . . , y_{Nall}) belonging to the teacher data is r (r<N_{f}), the deviation vector (y_{target}) for the target does not necessarily belong to this r-dimensional space. For example, when a class including an image in a normal state for a certain object is considered, it is assumed that a dimension of a space formed by a deviation vector (y₁, . . . , y_{Nall}) for the image in the normal state is r (r<N_{f}). Even so, the deviation vector (y_{target}) for the target that is the image in the abnormal state does not necessarily belong to this r-dimensional space. In such a case, the zero singular value for the variance-covariance matrix (Σ) of the class consisting of images in the normal state is a “meaningful zero singular value”. Conversely, even for a deviation vector (y_{target}) for any target, if it always belongs to this r-dimensional space, the dimension larger than r is redundant, and the zero singular value for the variance-covariance matrix (Σ) is a nonsignificant zero singular value.

It is assumed that the rank of the variance-covariance matrix (Σ) related to the class including the image in the normal state is r (r<N_{f}). In this case, before calculating the Mahalanobis distance (d_{M}), the data processing device and the data processing method in the inference phase may perform the following determination processing as a coping method of the “meaningful zero singular value”.

$$for ∀ i ∈ \{ r + 1 , … , {N}_{f} \} \qquad ( 63 )$$

$$if \vert {\overbrace{{u}_{i}^{T} {y}_{target}}}^{∈ ℝ} \vert \geq ε \qquad then \qquad Not included in the class ( {d}_{M} = ∞ )$$

$$\begin{matrix}else & Proceed to\end{matrix} calculating {d}_{M}^{2} in dim = r$$

$$wherein$$

$$U {\vert}_{{N}_{all}} = : [ \begin{matrix}\begin{matrix}{u}_{1} & …\end{matrix} & {u}_{{N}_{f}}\end{matrix} ]$$

However, ε (epsilon) appearing in Mathematical Formula (63) is a threshold value of a machine epsilon or the like.

When the condition shown in Mathematical Formula (63) is true, the deviation vector (y_{target}) for the target does not belong to the class including the image in the normal state. If it is clear that the target does not belong to the class, it is not necessary to obtain the Mahalanobis distance (d_{M}) on purpose. Note that, in this case, to widely interpret it, the Mahalanobis distance is ∞ (infinity) as a result of division by the zero singular value. When the condition shown in Mathematical Formula (63) is true, the zero singular value for the variance-covariance matrix (Σ) of the class including the image in the normal state is a singular value that cannot be truncated, that is, “a meaningful zero singular value”.

Only when the condition shown in Mathematical Formula (63) is false, the data processing device and the data processing method in the inference phase execute processing of calculating the Mahalanobis distance (d_{M}) defined in the r-dimensional feature space.

The data processing device and the data processing method according to the present disclosed technology perform the following determination processing by applying Mathematical Formula (63) in a case where the low ranking approximation in which the dimension is regarded as k (k<r) is performed.

$$for ∀ i ∈ \{ r + 1 , … , {N}_{f} \} \qquad ( 64 )$$

$$if \vert {\overbrace{{u}_{i}^{T} {y}_{target}}}^{∈ ℝ} \vert \geq ε \qquad then \qquad Not included in the class , and end process$$

$$\begin{matrix}else & Proceed to\end{matrix} calculating {d}_{M}^{2} in dim = k$$

$$wherein$$

$$U {\vert}_{{N}_{all}} = : [ \begin{matrix}\begin{matrix}{u}_{1} & …\end{matrix} & {u}_{{N}_{f}}\end{matrix} ]$$

In a case where the low ranking approximation in which the dimension is regarded as k can be performed, the approximate value of the Mahalanobis distance is given by the following mathematical formula based on the rank-constrained general inverse matrix.

$${d}_{M}^{2} ∼ {( {d}_{M} )}_{k}^{2} = {( {\overline{y}}_{target} )}_{k}^{T} {( {\overline{y}}_{target} )}_{k} \qquad ( 65 )$$

$$wherein$$

$${\overbrace{{( {\overline{y}}_{target} )}_{k}}}^{∈ ℝ} := {\overbrace{[ \begin{matrix}\frac{1}{{σ}_{1}} & & \\ & ⋱ & \\ & & \frac{1}{{σ}_{k}}\end{matrix} ]}}^{∈ {ℝ}^{k \times k}} {\overbrace{[ \begin{matrix}\begin{matrix}{u}_{1}^{T} \\ ⋮\end{matrix} \\ {u}_{k}^{T}\end{matrix} ]}}^{Truncated {U}^{T} ∈ {ℝ}^{k \times {N}_{f}}} {\overbrace{{y}_{target}}}^{∈ {ℝ}^{{N}_{f} \times 1}}$$

The “variable in which y is accented with a bar” defined in the second expression of Mathematical Formula (65) is referred to as a “normalized deviation vector for the target” or simply as a “normalized deviation vector” in the present specification. Note that even in a case where the low ranking approximation is not performed, the same vector is referred to as a “normalized deviation vector” (see Mathematical Formula (62)).

Mathematical Formula (64) gives a condition for performing the low ranking approximation when calculating the Mahalanobis distance. Conditions under which the low ranking approximation may be performed are as follows.

$$for ∀ i ∈ \{ k + 1 , … , {N}_{f} \} and ∀ {y}_{target} \qquad ( 66 )$$

$$\vert {\overbrace{{u}_{i}^{T} {y}_{target}}}^{∈ ℝ} \vert < ε$$

Mathematical Formula (66) represents that the absolute values of all the (k+1) th to N_{f}-th coordinate components are less than & (epsilon) when the coordinates of y_{target} are viewed in the N_{f}-dimensional space defined by the basis vectors of u₁ to u_{Nf}. That is, the condition under which the low ranking approximation may be performed is that the deviation vectors (y_{target}) for all targets are elements of a k-dimensional subspace formed by the deviation vectors (y₁, . . . , y_{Nall}). Therefore, the low ranking approximation should not be performed unless there is a circumstance such as empirically predicting that “Deviation vectors (y_{target}) for all targets to be measured in the future become elements of a k-dimensional subspace formed by the deviation vectors (y₁, . . . , y_{Nall})”.

In the present specification, the condition given by Mathematical Formula (66) is referred to as a “condition under which a low ranking approximation can be performed”. In a case where it is unknown whether or not an object (application example) to which the present disclosed technology is to be applied satisfies an implementable condition of the low ranking approximation, the data processing device and the data processing method only need to perform determination processing represented by Mathematical Formula (63) or Mathematical Formula (64) in the inference phase.

The inventor of the present disclosed technology has found that, in the abnormality detection processing by PaDiM, even if the original dimension of N_{f}=1792 is reduced to k=20, the “condition under which a low ranking approximation can be performed” shown in Mathematical Formula (66) is satisfied.

A technical feature specific to the data processing device and the data processing method according to the fifth embodiment is that the data processing device and the data processing method include a coping method of “a meaningful zero singular value”.

With this technical feature, the data processing device and the data processing method according to the fifth embodiment also have an effect of being able to solve learning problems such as “classification” and “clustering” by using a full N_{f}-dimensional space as a feature space in an inference phase even in a case where a variance-covariance matrix (Σ) related to a certain class is not full-rank.

### Sixth Embodiment

A data processing device and a data processing method according to a sixth embodiment are modifications of the data processing device and the data processing method according to the present disclosed technology. Unless otherwise specified, in the sixth embodiment, the same reference numerals as those used in the above-described embodiments are used. In the sixth embodiment, the description overlapping with the previously described embodiments is appropriately omitted.

Meanwhile, FIG. 5 according to the first embodiment illustrates a flowchart in a case of using a k-dimensional feature space mapped by a fixed singular vector ((U)ₖ^{T}). As described above, in order to use the fixed k-dimensional subspace projected by the fixed singular vector, it has been necessary that the data is sufficiently rich, that is, sufficient information is acquired to reproduce the property of the class to which the data belongs.

The data processing device and the data processing method according to the present disclosed technology include means for determining whether or not data is sufficiently rich, specifically, an end condition for loop processing related to data update.

### (End Condition for Loop Processing Related to Data Update)

On the basis of the information when the number of pieces of data is N_{d}+1 and the number of pieces of data is Na, the end condition for the loop processing related to the data update is given as follows, for example.

$$for ∃ i ϵ \{ 1 , … , {N}_{f} \} \qquad ( 67 )$$

$$\begin{matrix}\vert {σ}_{i} {\vert}_{{N}_{d} + 1} - {σ}_{i} {\vert}_{{N}_{d}} \vert & < & {ε}_{σ} \\ & ⋂ & \\ ‖ {u}_{i} {\vert}_{{N}_{d} + 1} - {u}_{i} {\vert}_{{N}_{d}} ‖ & < & {ε}_{u}\end{matrix}$$

Here, ε_{σ} appearing in Mathematical Formula (67) is a threshold value for the singular value, and εᵤ is a threshold value for the singular vector. ε_{σ} and εᵤ may be the same value or different values. Furthermore, the singular value (σᵢ) and the singular vector (uᵢ) appearing in Mathematical Formula (67) relate to the variance-covariance matrix (Σ) described below.

$$\begin{matrix}\sum {\vert}_{{N}_{d}} & = [ \begin{matrix}{u}_{1} {\vert}_{{N}_{d ,}} & ⋯ & {u}_{{N}_{f}} {\vert}_{{N}_{d}}\end{matrix} ] [ \begin{matrix}{{σ}_{1} \vert}_{{N}_{d}} & & \\ & ⋱ & \\ & & {σ}_{{N}_{f}} {\vert}_{{N}_{d}}\end{matrix} ] [ \begin{matrix}{u}_{1}^{T} {\vert}_{{N}_{d}} \\ ⋮ \\ {{u}_{{N}_{f}}^{T} \}}_{{N}_{d}}\end{matrix} ]\end{matrix} \qquad ( 68 )$$

$$\sum {\vert}_{{N}_{d} + 1} = [ \begin{matrix}{u}_{1} {\vert}_{{N}_{d} + 1} & ⋯ & {u}_{{N}_{f}} {\vert}_{{N}_{d} + 1}\end{matrix} ] [ \begin{matrix}{{σ}_{1} \vert}_{{N}_{d} + 1} & & \\ & ⋱ & \\ & & {σ}_{{N}_{f}} {\vert}_{{N}_{d} + 1}\end{matrix} ] [ \text{} \begin{matrix}{u}_{1}^{T} - {\vert}_{{N}_{d} + 1} \\ ⋮ \\ {u}_{{N}_{f}}^{T} {\vert}_{{N}_{d} + 1}\end{matrix} ]$$

To determine whether or not the data is sufficiently rich, even if the singular value and the singular vector for the variance-covariance matrix (Σ) cannot be directly observed, it is sufficient if the singular value and the singular vector for the variance-covariance matrix (Σ) can be indirectly observed. A method of indirectly observing the singular value and the singular vector for the variance-covariance matrix (Σ) is specifically to observe the correlation matrix.

In the case of the data processing device and the data processing method according to the first embodiment, the singular value and the singular vector for the SVD of the correlation matrix derived from the SVD of the gram matrix shown in Mathematical Formula (23) are preferably used as the end condition shown in Mathematical Formula (67).

In the case of the data processing device and the data processing method according to the second embodiment, the singular value and the singular vector for the SVD of the correlation matrix derived from the SVD of the gram matrix shown in Mathematical Formula (42) or (43) may be used as the end condition shown in Mathematical Formula (67).

In the case of the data processing device and the data processing method according to the third embodiment, the singular value and the singular vector for the SVD of the correlation matrix derived from the SVD of the gram matrix obtained by the eigenvalue decomposition or the like of the M^{T}M are preferably used as the end condition shown in Mathematical Formula (67).

A technical feature unique to the data processing device and the data processing method according to the sixth embodiment include an end condition for loop processing related to data update.

With this technical feature, the data processing device and the data processing method according to the sixth embodiment also have an effect that the end of the loop processing can be determined on the basis of the determination as to whether or not the data is sufficiently rich.

### INDUSTRIAL APPLICABILITY

The data processing device and the data processing method according to the present disclosed technology can be applied to a defect inspection device that performs abnormality determination, for example, a defect inspection device of a photomask for a semiconductor, and have industrial applicability.

### REFERENCE SIGNS LIST

100: data processing device, 110: input interface, 120: processing circuit, 122: processor, 124: memory, 130: output interface

1. A data processing device, comprising a processing circuit, wherein
the processing circuit sequentially updates a gram matrix in a form of SVD in a learning phase, and
the processing circuit calculates a variance-covariance matrix in a form of SVD on a basis of SVD related to the gram matrix in Finalization of the learning phase.

2. A data processing device, comprising a processor that executes a program, wherein
the processor executes the program to sequentially update a gram matrix in a form of SVD in a learning phase, and
the processor executes the program to calculate a variance-covariance matrix in a form of SVD on a basis of SVD related to the gram matrix in Finalization of the learning phase.

3. The data processing device according to claim 2, wherein
the program includes a function having SVD of Z, A, and B as inputs and SVD of Z+AB^{T} as an output,
where A, B, and Z are each a matrix.

4. The data processing device according to claim 2, wherein the program includes a function that outputs SVD of an extended system.

5. The data processing device according to claim 2, wherein the program includes a function that outputs an eigenvalue decomposition of a matrix (M^{T}M) represented in a quadratic form.

6. The data processing device according to claim 2, wherein the program includes a function that sequentially calculates a correlation matrix for verification, not in the form of SVD.

7. The data processing device according to claim 2, wherein the program includes a function of coping with a zero singular value having a meaning.

8. The data processing device according to claim 2, wherein the program includes a function that determines end of loop processing on a basis of determination as to whether or not training data is sufficiently rich.

9. A data processing method, comprising:
sequentially updating a gram matrix in a form of SVD in a learning phase; and
calculating a variance-covariance matrix in the form of SVD on a basis of the SVD related to the gram matrix in Finalization of the learning phase.

10. The data processing method according to claim 9, comprising a numerical calculation with SVD of Z, A, and B as inputs and SVD of Z+AB^{T} as an output,
where A, B, and Z are each a matrix.

11. The data processing method according to claim 9, comprising a numerical calculation for outputting SVD of an extended system.

12. The data processing method according to claim 9, comprising a numerical calculation for outputting an eigenvalue decomposition of a matrix (M^{T}M) represented in a quadratic form.

13. The data processing method according to claim 9, further comprising a numerical calculation for sequentially calculating a correlation matrix for verification not in the form of SVD.

14. The data processing method according to claim 9, comprising processing of coping with a zero singular value having a meaning.

15. The data processing method according to claim 9, comprising processing of determining an end of loop processing on a basis of a determination as to whether or not training data is sufficiently rich.
